(19) United States
(12) Patent Application Publication
(10) Pub. No.: US 2004/0158814 A1
(43) Pub. Date: Aug. 12, 2004

(54) Structured objects

(76) Inventors: David Christopher Tracey, Drogheda (IE); Brian Joseph Gillespie, Drumcondra (IE)

Correspondence Address: B. Noel Kivlin, Meyertons, Hood, Kivlin, Kowert & Goetzel, P.C., P.O. Box 398, Austin, TX, 78767, US

(21) Appl. No.: 10/359,791

(22) Filed: Feb. 6, 2003

(51) Int. Cl. G06F 9/44

(52) U.S. Cl. 717/120; 717/168; 717/174

(57) ABSTRACT

An object structure provides a framework for defining objects in an object space that can separately identify instance information and descriptor information for an object. The co-ordination of complex independent components (processes, threads, tasks, etc.) can be managed by linking those components together within a global environment that includes the object space.

### BACKGROUND OF THE INVENTION

This invention relates to defining objects in an object space.

It is known to define objects in terms of a shared global space called Tuple Space. Tuple Space provides a structure or environment within which objects can be defined and operations can be performed on the objects. Various operations can be defined, including, for example, a put operation to an object into the space, and operations to read and/or write to an object, to take and to evaluate an object. A programming language called Linda, that enables the manipulation of Tuple Space is described in an article entitled “Linda in Context”, by N Carriero and D Gelernter, published in Communications of the ACM, vol. 32, no.4, April 1989, pages 444-458. Linda is a co-ordination language that enables dynamic composition of computational components (devices and software components). Linda relies on asynchronous and associative communication based on Tuple Space. It enables the development of complex software by managing co-ordination aspect of an application. The term “co-ordination” here refers to the process of building programs by gluing together their independent active components (processes, threads, tasks, etc.).

Another concept similar to the Tuple Space is known as JavaSpaces. However, JavaSpaces defines a set of operations that are different from those in Tuple space. Specifically, although JavaSpaces provides for notify, read, write and take operations, it does not provide for an evaluate operation.

A programming language called Jini provides an environment that employs JavaSpaces as a common distributed computing space to enable hardware and software components (hereinafter components) distributed over a network to be referenced through objects defined with respect to JavaSpaces. The environment provides shared services (e.g., communication mechanisms, users, hardware devices, storage devices, etc.) that are accessed by the various components. The components communicate using a set of Java interfaces known as the service protocol, and they locate each other using a look up service. A discovery protocol is also used to register or locate a service using the look-up service. The so-called Java Remote Method Invocation (RMI) API as specified in the Java Development Kit (JDK) version 1.2 is used for low-level communication. Each component has an access control list (ACL) describing which other components are allowed access to it. In use, a component that sends out a service request is known as the principal and communicates with other components needed to perform a service. The look-up service, the discovery protocol, a distributed security system and the RMI together form the so-called Jini infrastructure.

A Jini programming model provides a leasing system, a transaction system, and a distributed events model. All services are granted as leases that are time dependent and that have to be renewed on expiry. The leases can be exclusive or non-exclusive, whereby they can be registered as being leased to one or more other services. The transaction system keeps records of the transaction environment before and after the transaction is processed so that it can be undone if necessary. The distributed event model is based on JavaBeans, whereby an event enables services to indicate that an action is to be taken.

Jini employs JavaSpaces as a simple mechanism for accessing and processing distributed objects. At a general level this works by a client application making contact with a JavaSpaces server. The client can request a particular type of object by providing a template that describes the form of the object. The server will then respond with an entry that best fits the template description. Appropriate ones of the read, take, write and notify operations mentioned above can then be performed.

For example, the client can initiate a read transaction to make a copy of the entry object within that space and to work with it. Alternatively, the client can initiate a take transaction to take, or remove, an existing entry object from that space. After processing the entry object as required the client can then initiate a write transaction to replace the entry object back into the space. A client can also initiate a notify transaction to alert the system that it is waiting for the entry object or to find out when the entry object is changed.

Thus, JavaSpaces provides a common distributed computing space to enable hardware and software components (hereinafter components) distributed over a network to be referenced through objects in the context of a Java application. However, there remains a need for a simple object framework that can be used by applications written in a programming language other than the Java programming language.

### SUMMARY OF THE INVENTION

Aspects of the inventions are defined in the appended claims.

For example, an aspect of the invention provides an object structure for defining objects in an object space. The object structure can separately identify at least instance information and descriptor information for an object.

An object space in this context is similar to a Tuple space in that it is where an object is stored by, and available to, calling programs. An object can be stored by, and be available to, calling programs via defined and simple interface, which is the same for all objects. The calling programs do not need to have knowledge of how their object is stored in or retrieved from the space other than the interface calls available. This decoupling allows many different types of objects to be accommodated while still permitting access to the object structure through the use of simple functions such as add, remove, get, and notify transactions.

The object structure can further define lease information for the object defining a minimum existence time for the object in the object space. Thus, for example an object can be arranged to have a lifetime related to the minimum existence time. If it is not refreshed during this lifetime, then it expires at the end of the lifetime. This can provide for efficient garbage collection without complex garbage collection algorithms being required.

For example, an object representor can be provided representing a first object. The object representor can reference an instance representor that represents an instance of the first object and a descriptor representor representing a descriptor of the first object. The descriptor representor can further represent lease information defining the minimum existence time for the first object in an object space.

The term “representor” is used herein to refer to a software component that has characteristics of an object, but is itself used to represent an object, and instance or a description of the object. Accordingly, as the “representor” is a form of object, a term such as “structure object” could be used to refer to these software components. However, the term “representor” is used herein for reasons of clarity to differentiate the software components from the object/instance/description that they represent.

A link can be provided to a first instance object representor of a plurality of instance representors for respective instances of the first object. A link can also be provided to a first descriptor representor of a plurality of descriptor representors for respective descriptors of the first object.

The first object representor further includes one or more of:

name information for the first object;

handle information for the first object;

type information for the first object;

handle information for a descriptor for the first object; and

private information for the first object.

The first object representor can further include link information to at least one of a next and a previous object representor in the object structure. The first object representor can further includes link information to at least one of a parent and a child object representor for nested objects in the object structure.

The object structure can be accessible using functions selected from add, remove, get and notify functions. At least one object representor can define an object space, and an object space can include an object structure as set out above.

Another aspect of the invention provides a method of providing an object framework for managing objects in an information system, the method comprising creating an object structure separately identifying at least instance information and descriptor information for an object.

A further aspect of the invention provides a computer program comprising program code operable to implement the aforementioned object structure and/or method.

Further aspects and advantages of the invention will become apparent from the following description of a preferred embodiment.

### BRIEF DESCRIPTION OF THE DRAWINGS

Embodiments of the present invention will be described hereinafter, by way of example only, with reference to the accompanying drawings in which like reference signs relate to like elements and in which:

FIG. 1 is a schematic representation of a front view of an example of a carrier forming a rack mountable shelf carrying a plurality of field replaceable units;

FIG. 2 is a rear view of the shelf of FIG. 1;

FIG. 3 is a functional block diagram of components of an example of field replaceable unit in the form of an information processing subsystem;

FIG. 4, which is formed by combining FIGS. 4A and 4B, is a functional block diagram of components of an example of field replaceable unit in the form of a combined switch and service processor module;

FIG. 5 is a functional block diagram showing the external connectivity of the shelf of FIG. 1;

FIG. 6 is a schematic representation of a rack-mounted system comprising a plurality of such shelves;

FIG. 7 is a schematic representation of a space within which object representors can be defined;

FIG. 8 is a schematic representation of an example of object representors; and

FIG. 9 is a flow diagram illustrating examples of operation of an embodiment of the invention.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### DESCRIPTION OF PARTICULAR EMBODIMENTS

Embodiments and examples are described hereafter by way of example only in the following with reference to the accompanying drawings.

An embodiment of the invention provides a simple object framework that can be used by applications written in an object-oriented programming language. In the following, an example of the present invention will be described for applications written in the “C” programming language, although it should be understood that the invention is not limited in its application to the “C” programming language, this being merely one example of a suitable programming language to which the present invention could be applied.

Before describing an embodiment of the present invention, there follows a description of an example of a multiprocessor computer system in which the present invention may be implemented. It should be noted that the system to be described is merely one example of a system in which the present invention may be implemented and that the invention could be applied to the management of other types and configurations of systems.

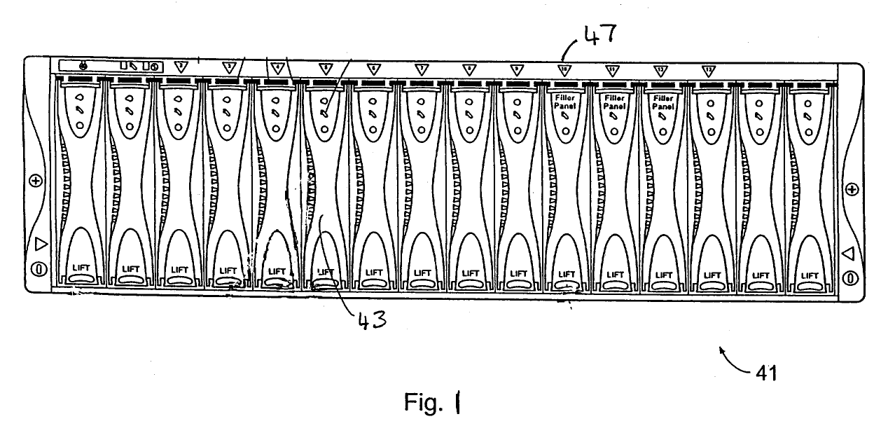

FIG. 1 is a front view of an example of a rack mountable shelf 41 that forms a carrier configured to carry a plurality of information processing cartridges 43 located side by side along the front of the shelf 41. The term “shelf” is used herein in a conventional way to describe a structure that is mountable in rack system and is configured to carry one or more components to form at least a part of a rack-mountable system.

This example of a shelf 41 has a single enclosure, or housing 47, that houses a number of modular units or subsystems, the majority of which are replaceable in the field and are therefore known as Field Replaceable Units (FRUs). These modular units include the information processing cartridges, or blades 43. Each information processing cartridge 43 in the present example is operable as a server. In the described examples, the information processing cartridges are configured as robust enclosed modules.

In the present example of a shelf, up to sixteen information processing cartridges 43 can be installed in respective receiving locations in the front face of the shelf 41. The number of information processing cartridges 43 actually installed in any installation is dependent upon the system configuration required.

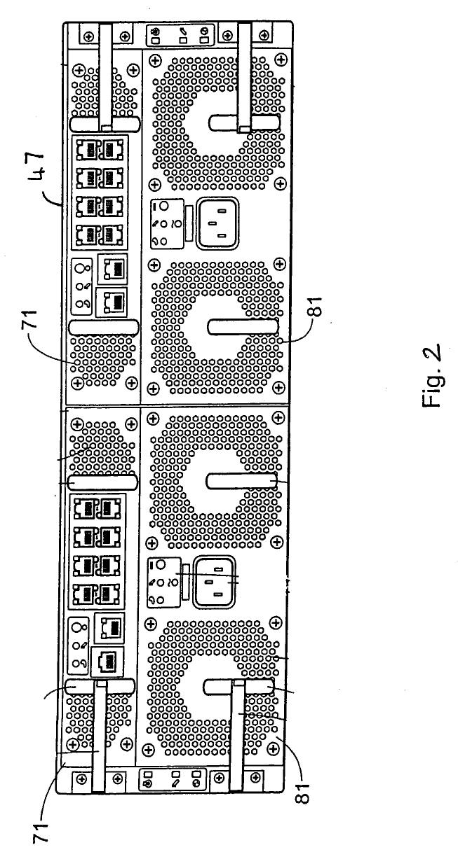

FIG. 2 illustrates the rear of the shelf unit of FIG. 1. This shows two different types of FRU 71 and 81 (4 units in total) that have been inserted into respective apertures and in the rear of the shelf enclosure 47. The FRUs shown in FIG. 2 include two Combined Switch and Service Processors (CSSPs) 71 and two Power Supply Units (PSUs) 81.

A midplane (not shown) is provided in the shelf enclosure 47 to interconnect the information processing cartridges to the FRUs mounted in the rear of the shelf 41.

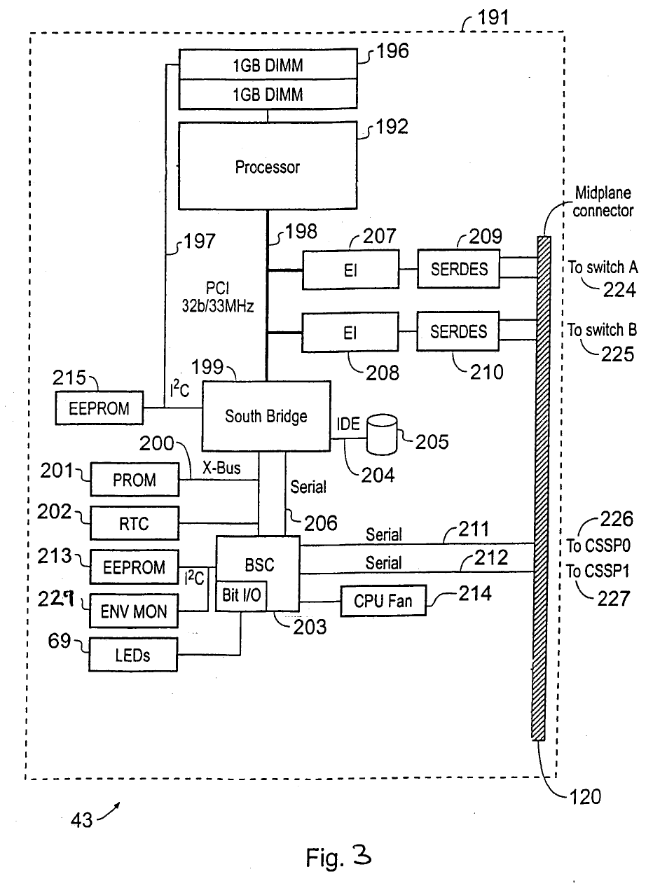

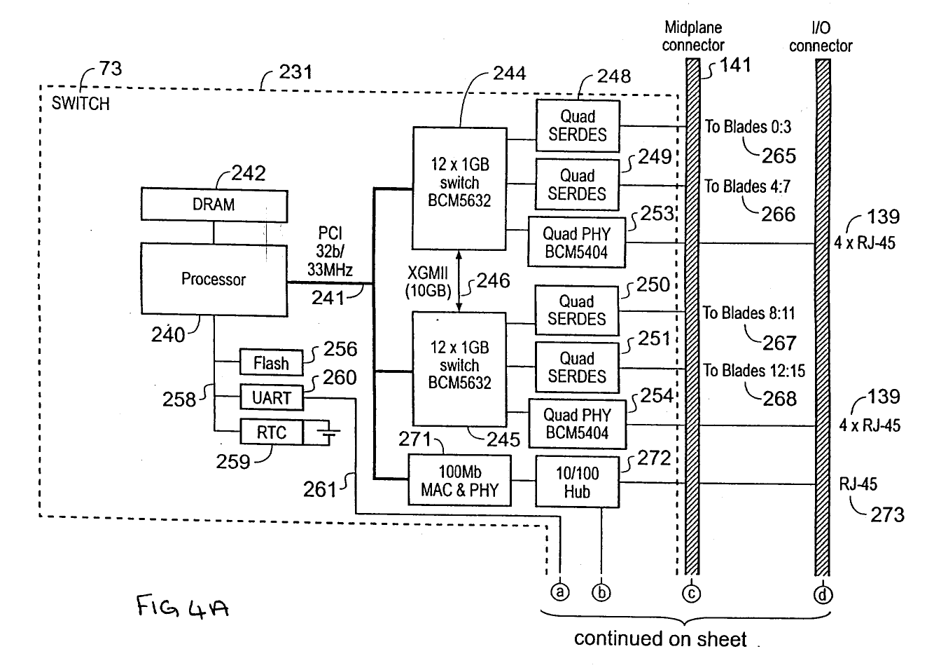

With reference to FIG. 3, there now follows a description of functional elements of an example of an information processing cartridge 43 as contained within an information processing cartridge enclosure.

A microprocessor 192 (e.g., an UltraSPARC™ processor) can be mounted on an information processing cartridge motherboard 191. Memory (e.g., dynamic random access memory (DRAM)) 196 can be provided.

A PCI bus 198 can connect microprocessor 192 to a so-called SouthBridge bus bridge 199. This is a standard form of bus bridge that provides the following functions: an SM Bus interface over an I2C bus 197 for access to a SPD (Serial Presence Detect) feature of the memory 196 that allows initialization of the memory controller; an Xbus interface for access via an Xbus 200 (which is a packet switched multiprocessor bus) to a PROM 201, a real time clock (RTC) 202 and an information processing cartridge service controller (hereinafter termed a Blade Service Controller (BSC)) 203; an IDE (Integrated Drive Electronics) interface that provides an ATA-100 (AT Attachment) IDE connection 204 to an IDE disk drive 205; and a serial console interface on a service bus 206 to the BSC 203 that is used for operating system functions including a console function with this embodiment.

A midplane connector 120 can establish connections between the information processing cartridge 43 and the midplane. These can include information signal connections 224 and 225, via Ethernet interfaces 207 and 208 and SERializer/DESerializers (SERDESs) 209 and 210. Asynchronous serial connections 211 and 212 can provide for communication between the BSC 203 and service processor parts of the CSSPs 71 via serial management signal connections 226, 227.

Internal data storage can be provided by the disk drive 205, which can hold an operating system (e.g., a Solaris operating system) and other software and data for performing information processing using the microprocessor 192.

The BSC 203 can provide various functions, including for example: dual access (for the information processing cartridges and the CSSPs 71) to the PROM 201 and an EEPROM 213 for boot information and a FRU-ID for the information processing cartridge; channeling communication between an information processing cartridge 43 and the service processor part of the CSSPs 71; control of power on reset (POR), system reset and externally initiated reset (XIR) to the microprocessor 192; control of power, service-required and ready-to-remove LEDs 69; upgrading of field-upgradable firmware, via the serial interface; a watchdog function for the operating system; monitoring the speed of a CPU fan 214; and communications with an EEPROM 215 and the operating system via the Xbus 200. An environmental monitor sensor 229 can monitor the CPU and ambient temperatures.

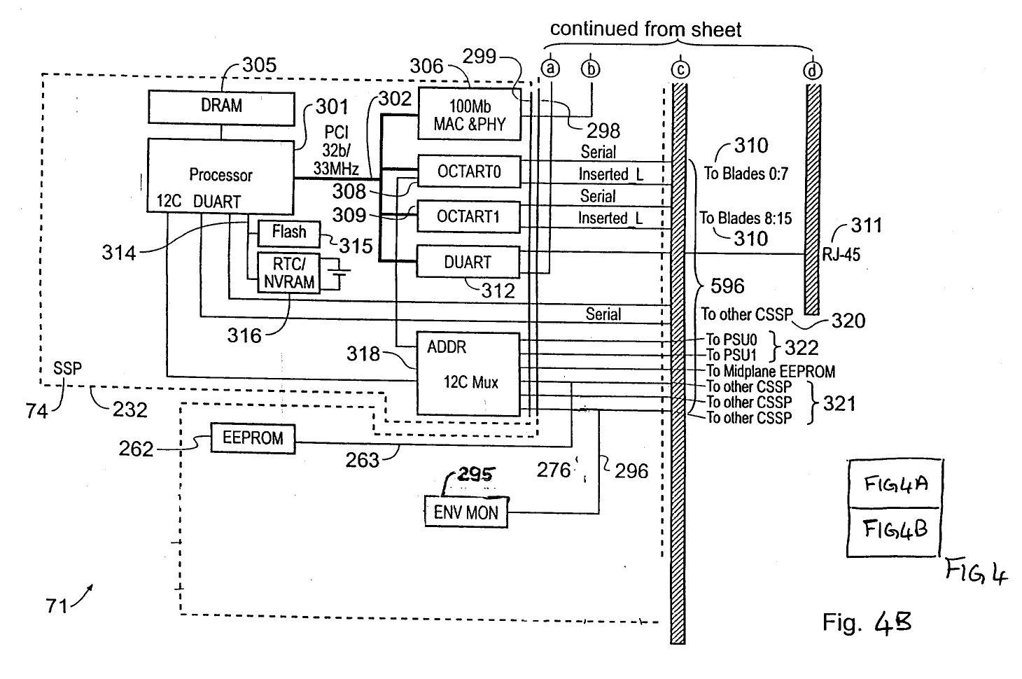

With reference to FIGS. 4A and 4B, there now follows a description of an example of a combined switch and service processor (CSSP) 71, which provides the functionality of a Switch 73 and of a Shelf Service Processor (SSP) 74. Most of the components relating to the Switch 73 are mounted on a Switch PCB 231, and the components relating to the SSP 75 are provided on a SSP PCB 232. However, components located in the lower portion of the switch PCB 321 (i.e., that portion below the SSP PCB 232 as illustrated in FIG. 4B) logically belong to the SSP 74, rather than to the switch 73. The switch PCB 231 carries the components associated with the switch, and it also carries the power, FRU-ID and environmental monitoring components along with the connectors for connections to the midplane and external connectors.

The functional elements of the Switch portions 73 of a CSSP 71 will now be described.

A switch microprocessor 240 with DRAM memory 242 can be provided. The processor 240 can be connected to a PCI bus 241. A flash PROM 256, accessible via an XBus 258, can store a real time operating system, and management and configuration data for the microprocessor.

The midplane connector 141 on the CSSP 71 establishes the connection between the CSSP 71 and the midplane 171. Switch ASICs (application specific integrated circuits) 244, 245 can provide Ethernet interfaces for uplinks and downlinks and an interface for chip-to-chip communication (bridging) 246 between the ASICs 244 and 245. Four quad SERDES 248-251 can allow each information processing cartridge 43 to communicate with the switch 73. Two quad PHYs 253 and 254 provide for external communication via RJ-45 connectors 139 on an IO connector panel.

A UART (Universal Asynchronous Receiver Transmitter) 260 interconnects the XBus 258 to a serial bus 261 for providing an asynchronous console connection from the switch 73 to the SSP 74 that is accessible to the SSP. An integrated MAC/PHY (Media Access Control/Physical) switch 271 can interface the PCI bus 241 to an Ethernet hub 272. The hub 272 can be operable to provide a management interface to the SSP 74 and a connection from an external management network to the switch 73 and SSP 74 of a given CSSP 71. The hub 272 can connect to an RJ45 connector 273 on the IO connector panel. An EEPROM 262 can be used to store the FRU-ID and is accessible by the SSP portion 74 of each CSSP 71 via a serial bus 263 and the midplane 171.

There now follows a description of functional elements of the Shelf Service Processor (SSP) portion 74 of a CSSP 71.

Communication between the Switch PCB 231 and the SSP PCB 232 is facilitated by an interboard connector pair 298 and 299.

The SSP 74 includes a microprocessor 301 (e.g., a Power PC processor) mounted on the SSP printed circuit board (PCB) 232. The processor 301 can be connected to a PCI bus 302. The processor 301 can also comprise a DUART to provide a redundant serial link to the SSP 74 of the other CSSP 71. The processor 301 can be provided with a DRAM memory 305. A flash PROM 315 can store a real time operating system, and management and configuration data for the microprocessor 301.

An integrated MAC/PHY switch 306 can interface the PCI bus 302 to the 10/100 Ethernet hub 272 via the interboard connectors 298, 299. Octal UARTs 308 and 309 can be connected between the PCI bus 302 and serial connections 310 on the midplane connector 141 via the interboard connector pair 298, 299. The Octal UARTS 308, 309 can facilitate serial communications between the SSP 74 and each of the processing cartridges 43. A dual UART (DUART) 312 can be connected between the PCI Bus 302 and serial bus 261 via the interboard connectors 298, 299 to provide an asynchronous console connection from the SSP 74 to the switch 73. The DUART 312 can also have an I2C connection to an external connector on the rear face 122 of the CSSP enclosure to provide a common operating system/boot console and command port 311.

To facilitate I2C communications between the SSP 74 and the other CSSP 71, the midplane and the PSUs 81, a multiplexer 318 can be provided. The multiplexer 318 can have a single I2C connection to the processor 301 and connections, via the interboard connector pair 298, 299 and the midplane connector 141 to both PSUs 81, the midplane 171 and the other CSSP 71.

The environmental monitor ENV MON 295 can be provided to maintain operational integrity of the CSSP 71 and can communicate with the SSP 74 of both CSSPs via an I2C bus 296.

There now follows a brief description of the Power Supply Units (PSUs) 81. These can be configured such that when two or more PSUs 81 are connected in parallel in the shelf 41, failure of any one of the paralleled units shall not affect system operation. Moreover, one of the PSUs can be installed or removed from a “live” system with or without input power applied. The outputs can have overcurrent protection. The PSU can have an I2C interface to provide power supply status via the midplane 171. The PSU can have an internal temperature sensor that reports via the I2C interface. The PSU fan speed can also be monitored and errors are reported via the I2C interface. Overvoltage and overcurrent sensors can also report via the I2C interface.

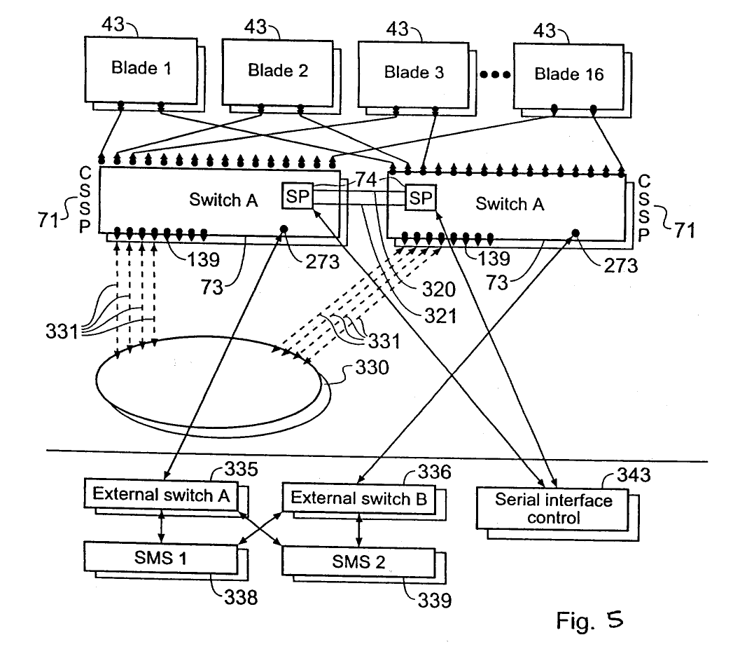

An example of data and control connectivity of the shelf 41 to and from computer systems external to the shelf 41 when the shelf 41 is arranged for use within a multiprocessor server system will be described with reference to FIG. 5.

In the present example each processing cartridge, or blade, 43 is connected to the switch 73 of each CSSP 71 by an information signal connection (e.g. a 1 Gb Ethernet link) formed by a combination of links 224, 225 from the processing cartridge 43 to the midplane 171, connections within the midplane 171 and links 265-268 from the midplane 171 to each switch 73. Further, a set of serial management signal connections comprising links 320, 321 and connections within the midplane 171 connect the SSP 74 of each CSSP 71 to the SSP 74 of the other CSSP 71.

To provide external data connectivity between the shelf 41 and an external core data network 330, in association with which all information processing performed by the processing cartridges 43 of the shelf 41 is undertaken, connections 331 can be formed between the core data network 330 and the eight Ethernet ports provided on the rear panel 122 of the CSSP enclosure.

In the present example, the connections by means of which control and configuration of the shelf 41 are performed are entirely separate to the connections to the core data network 330. Therefore, a first external switch 335 can connect to a management (I2C) port 273 of the first CSSP 71 and a second external switch 336 can connect to a management (I2C) port 273 of the second CSSP 72. As described above with reference to FIG. 4, the management port 273 can provide a management network interface to both the switch 73 and SSP 74 of each CSSP 71. The external switches 335, 336 can each be connected to each of a pair of System Management Server (SMSs) 338, 339. The SMS is not essential to the operation of the shelf 41, but use thereof aids optimal operation of the shelf 41. In a typical multiprocessor server system a plurality of shelves 41 may be connected together via the core data network 330 under the control of a single management network utilizing one set of SMSs 338, 339. A set of SMSs 338, 339 may comprise a single SMS (as well as a plurality thereof). However use of at least two SMSs enables redundancy of components, therefore increasing overall system reliability.

A serial interface control 343 operable under telnet protocol control is also connected to the shelf 41 in the present example. This can provide a common operating system/boot console connection to the SSP 74 of both CSSPs 71 via an RJ45 connector on the rear panel of each CSSP enclosure.

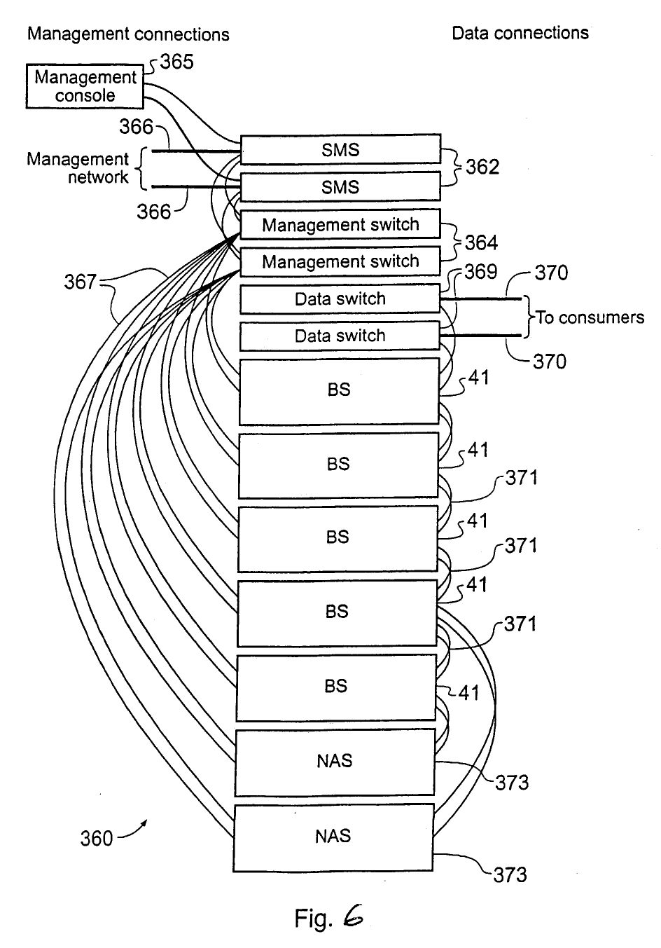

FIG. 6 illustrates how a plurality of shelves can be configured within one (or more) racks to provide even higher processing power. Such a constellation of shelves to provide a large grouping of servers is sometimes termed a “web farm” or “server farm” 360. As shown in FIG. 6, the web farm comprises a plurality of shelves 41 that each carry a plurality of blades 43. Also provided are a plurality of Network Attached Storage devices (NAS) 373 for providing storage for critical data, e.g. email data storage, for the web farm. The NASs 373 are not required if there is no critical data to be stored, e.g. if the web farm is operating solely to provide web caching services.

Management control of the web farm 360 can be provided through a pair of System Management Servers (SMSs) 362. Each SMS 362 can be connected to a management network via a link 366 and to a management console 365. The SMSs 362 can communicate with the individual shelves 41 via a pair of management switches 364. Each shelf 41 and NAS 373 can be connected to each management switch 364 via a connection 367. Thus dual redundant management connections can be provided to each shelf 41 and NAS 373.

Flow of data to and from the web farm 360 can be provided through a pair of data switches 369. Each data switch 369 can be connected to a consumer network via a link 370. It is to be understood that the consumer network can be a larger data network to which the web farm 360 is connected. This network can be an office or corporation intranet, a local area network (LAN), a wide area network (WAN), the Internet or any other network. Connections between the data switches and the shelves 41 can be facilitated by connections 371. It is to be noted that as each shelf has its own switching capability, there is no need for each shelf 41 to be directly connected to the data switches 369. Connections can also be provided to connect the NAS units 373 to the shelves 41. The topology used for interconnection of the data switches 369, shelves 41 and NASs 373 can be any topology providing at least one connection of any length between every possible pair of units. Complex topologies arranged to minimize the maximum connection length between any two given units in the web farm can be used.

As an alternative to providing critical data storage within a NAS 373, such storage can be provided within one or more NAS cartridges fitted into one or more of the shelves 41 in place of processing cartridges 43. Another alternative is to provide a server shelf with local storage such as a RAID array (Redundant Array of Inexpensive Disks) in place of the NAS 373.

The system described above provides an example of a fully configurable computing system based on a plurality of self contained field replaceable units (FRUs) and scalable from a single processing cartridge with power supply and switching capability to a multiply redundant multiprocessor server system with full system management capability extending over a number of co-operably connected server shelves. It will of course be readily apparent to the skilled reader that many of the specific features specified in the above description are in no way limiting and a variety of alternatives may be produced using only ordinary skill and common general knowledge.

For example, rather than the use of UltraSPARC™ processors in the information processing modules or in the CSSPs, other processors could be used. Also, multiple processors could be provided within a processing module. Each module within a shelf or a farm or shelves could run under the same operating system, or a plurality of different operating systems may be used. Also, it is not necessary that each processing cartridge within a shelf or farm be configured to run the same program software. For example, individual processing cartridges may be configured to execute, for example, fileserver software, mailserver software, webhosting software, database software, firewall software, or verification software. Further, although in the described example, the functionality of a switch and of a shelf service processor is provided within a single combined unit, separate switch and shelf service processor FRUs may be used. Also, although information signal connections based on an Ethernet protocol are described, other information signal communication protocols (e.g. Infiniband) could be employed. Similarly, a configuration of other than a pair of PSUs and a pair of CSSPs may be provided so as to provide an appropriate degree of FRU redundancy.

One aspect of ensuring maximum possible computer availability relates to service and management of a computer system. In particular, service and management functions are in general required for monitoring system status and performing control actions in response to monitored parameters. There now follows an example of how service functions may be implemented in a hierarchical manner through different components of a modular computer system.

As described above with reference to FIG. 3, each information processing cartridge 43 has a blade service controller 203. The blade service controller 203 is a local controller of service functions for each information processing cartridge 43. Each blade service controller 203 is arranged to be able to communicate with the SSP 74 (see FIGS. 4 and 6) of each CSSP 71 via the connections 226, 227 and 310. The SSP 74 provides shelf-level service functions for the population of each shelf 41, which includes the PSUs 81 and the switches 73 of the CSSPs 71 as well as the processing cartridges 43. Each SSP 74 is arranged to be operable to communicate with an external system management server (SMS) 338, 339 via I/O connector 273 as illustrated in FIG. 4A. The system management server provides system level service functions for one or more shelves 41. The system management server may also provide service functions to computer system modules other than shelves 41 within a computer system, for example to individual server units and/or to reliable storage units such as Network Addressable Storage (NAS) units.

In the present example, the blade service controller 203 can provide the following service functions. It typically performs environmental monitoring of the information processing cartridge 43 within which it is situated, this includes monitoring of CPU and ambient temperatures by means of the environmental monitor 215, monitoring of the power supply rails from the DC to DC converter 218 and monitoring of the speed of the processor cooling fan 214. The blade service controller 203 may also perform a watchdog function for monitoring the operating system running on the processor of the processing cartridge 43. The blade service controller 203 can also provide an out-of-band interface between the processing cartridge 43 and the CSSP 71. The out-of-band interface is a physically discrete interface, which is independent of the operating system, and applications running on the processor, this interface may be used for providing processor cartridge parameters to the shelf SSPs 74 at boot. In addition, the blade service controller 203 may also provide local functions for control of the LED service indicators 119 and control of power on reset (POR) and externally initiated reset (XIR) to the processor. In the present example, there is no requirement for the blade service controller 203 to have any level of intelligence, it being sufficient that it is capable of performing simple watchdog and threshold type monitoring operations. However, the blade service controller 203 my be implemented having intelligence, which may be of particular benefit in the event that it is tasked with more complex functions than those set out above.

The SSP 74 (of which two are typically provided within a shelf 41 to provide redundancy) provides the following functions in the present example. It typically performs environmental monitoring for the shelf 41, monitoring the PSUs 81, the CSSPs 71 and the PSU inputs. The SSP 74 can also aggregate data from the blade service controller 203 of each blade 43 present in the shelf. The SSP 74 may also be configured to make decisions regarding aspects such as power control, control of the shelf service indicator LEDs 69 and to provide instructions to the blade service controllers 203. In the present example, the SSP 74 is not responsible for deployment of software to individual processing cartridges, however this function may be provided by the SSP 74 in alternative arrangements.

In order to provide a facility for manual monitoring and control of the SSP 74, it may be configured to have a user interface via which a user can be provided access to the functions and data of the SSP 74. The user interface access may be provided through one of the external serial interface connection 311 and the external network connection 273. The SSP 74 may be operable to operate as an isolated unit with no higher level service control provided. In general the SSP 74 requires little or no user intervention to manage the operation of a single shelf 41.

Fault management may be controlled by the SSP 74 such that a failed processing cartridge 43 (the failure of which may be detected, for example, from data provided by a blade service controller 203 indicating a failure of the processing cartridge's operating system or application or from errors detected in the switch 73) may be remotely restarted by the SSP 74, in the present example either by initiating an externally initiated reset (XIR) to the processor of the processing cartridge, or by causing an interruption in the power supply to the processing cartridge sufficient to cause a power on reset (POR) to the processor of the processing cartridge. In the present example, a failed processing cartridge will be the subject of a predetermined number of restart attempts before that processing cartridge is considered permanently failed, at which time the processing cartridge is removed from service in that it is ignored by the SSP 74 and the switch 73 is instructed to pass traffic to it and to ignore any traffic from it and the failed nature is reported to any higher level service control to which the SSP 74 is connected.

In order to perform the above described functions, the SSP 74 of the present example is configured to have a degree of intelligence such that decision making steps and provision of a user interface are supported.

The system management server (SMS), of which two (338 and 339) are typically provided as a clustered pair for redundancy (as illustrated in FIG. 5), is in the present example configured to provide the following functions. The primary use of the server management system 338, 339 of the present example is to provide aggregate management and monitoring for a number of shelves 41 (as illustrated in FIG. 6). By means of such aggregated monitoring and management, a single (clustered pair of) system management server(s) can oversee the running of a large number of computer system shelves 41.

The system management server (SMS) 338, 339 may also be operable to perform hardware fault failover in response to hardware failures detected by the system management server or reported to it by an SSP 74 of a particular shelf 41. In addition, the system management server 338, 339 of the present example may be operable to perform software deployment to individual processing cartridges. In alternative arrangements, the system management server 338, 339 may be operable to allow platform specifics abstraction.

By “platform abstraction” is to be understood that the SMS 338, 339 may be operable to allow platform specific abstraction such that the user may configure computing services without knowledge of the underlying hardware providing these services. For example a user may require a web server which can cope with, say, 1000 connections per an hour. The SMS 338, 339 may be pre-configured with enough platform specific data to determine how many blade servers are required to fulfil this requirement, based on their processor, memory size, etc and provision the web service on that number of blade servers without the user needing to know anything about the server hardware details himself.

As mentioned above, an embodiment of the present invention provides a simple object framework that can be used by applications written in an object-oriented programming language. An object structure enables objects to be defined in an object space by separately identifying instance information and descriptor information for the objects. By decoupling the details of an object into descriptor and instance many different types of objects can be accommodated while still permitting access to the object structure through the use of simple functions such as add, remove, get, and notify functions. Lease information for the object can define a minimum existence time, or lifetime, for the object in the object space such that if it is not refreshed the object then expires at the end of the minimum existence time or lifetime.

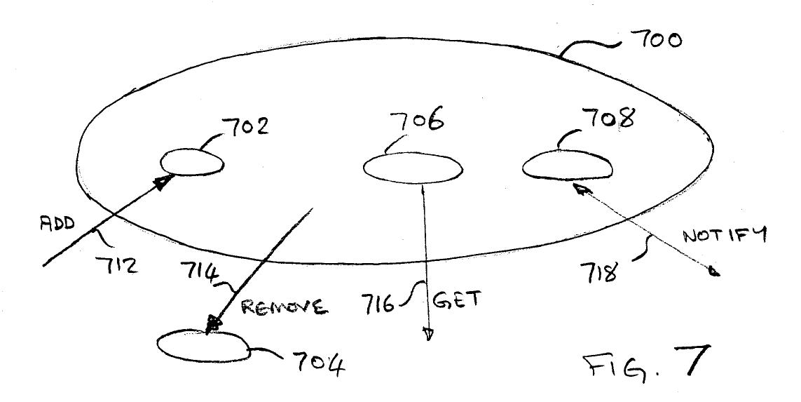

FIG. 7 provides a schematic representation of an object space containing a number of object representors 702, 704, 706 and 708 representing objects in the object space. FIG. 7 also illustrates examples of ADD, REMOVE, GET and NOTIFY operations 712, 714, 716 and 718, respectively.

As mentioned above, the term “representor” is used herein to refer to a software component that has characteristics of an object, but is itself used to represent an object, and instance or a description of the object. Indeed the relationships between objects in the space is determined purely by the program calling the add/remove functions by filling in fields in the representor. By being decoupled from these relationships in this way, the object space can accommodate many different calling programs, and their objects, independently of each other.

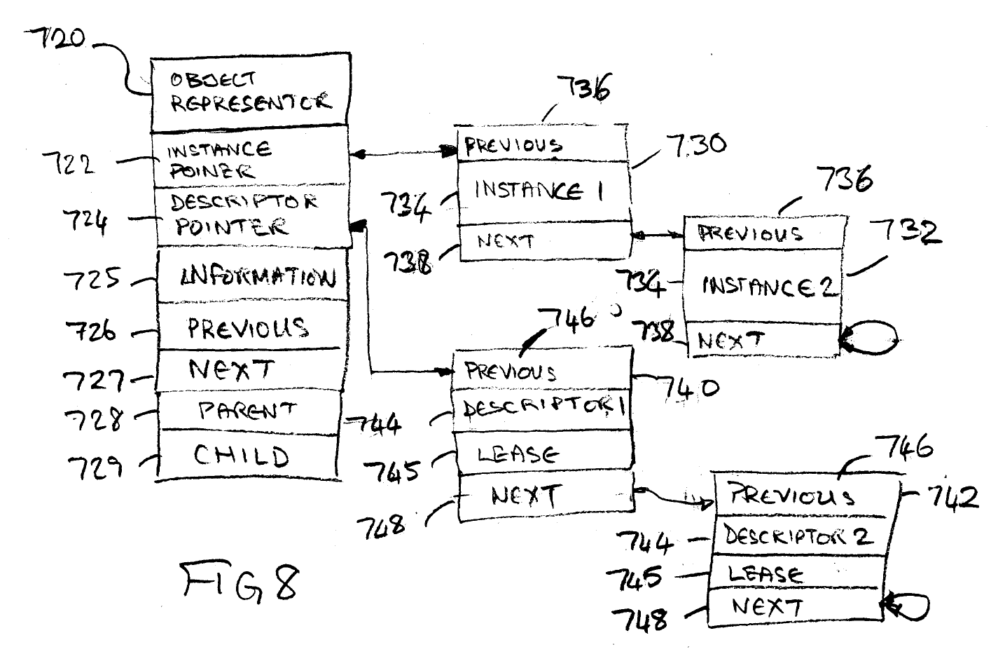

As is illustrated in an example of a storage methodology in FIG. 8, an object can include one or more instance representors 730, 732 that each represent a respective instance 734 of the object and one or more descriptor representors 740, 742 that each represents a respective descriptor 744 of the object. One or more of the descriptor representors 740, 742 can further identify lease information 745 defining the minimum existence time for the first object in an object space.

As further illustrated in the example of a storage methodology in FIG. 8, an object representor 720 includes an instance link 722, that can be arranged to provide a link to a first instance representor 730 of a plurality of instance representors 730, 732 for respective instances of the object. As further illustrated in FIG. 8, a descriptor link 724, otherwise known as a descriptor template, can be arranged to provide a link to a first descriptor representor 740 of a plurality of descriptor representors 740, 742 for respective descriptors of the object. A template is itself an object and so can be stored in the object space and can be used to describe the shared properties of a related set of instances, such as their class definition with property types etc, whereas the instance objects would hold the values of those properties.

In the example shown in FIG. 8, the instance representors are implemented in the form of a doubly linked list, with each instance representor including a previous link 736 identifying a previous instance representor in the list (or, in the case of the first instance representor in the list, the object representor 720) and a next link 748 identifying a next instance representor in the list (or, in the case of the last instance representor in the list, identifying itself or a null value or the like, to indicate the end of the list).

Further, in the example shown in FIG. 8, the descriptor representors are implemented in the form of a doubly linked list, with each descriptor representor including a previous link 746 identifying a previous descriptor representor in the list (or, in the case of the first descriptor representor in the list, the object representor 720) and a next link 738 identifying the next descriptor representor in the list (or, in the case of the last descriptor representor in the list, identifying itself or a null value or the like, to indicate the end of the list). It is to be noted the storage methodology used is transparent to a calling program and therefore the calling program will be unaware of the form that the internal storage of the objects takes (e.g., the linked lists in the object space in the present example). Indeed, any applicable storage methodology could be used in the object space.

An object representor 720 can include information 725 that comprises one or more of:

name information for the first object;

handle information for the first object;

type information for the first object;

handle information for a descriptor for the first object; and

private information for the first object.

The object representor 720 can further include links 726 and 727 to at least one of a next and a previous object representor in the object structure. The first object representor can further include links 728 and 729 to at least one of a parent and a child object representor for nested objects in the object structure.

In the present example, the object structure can be accessed using get, remove, add and notify operations.

For example, the client can initiate a get operation to make a copy of an object representor within the object structure to work with it. The get transaction effectively reads the data from the object representor for the object concerned.

The client can also initiate a remove transaction to remove an existing object representor from the object structure. Removing the object representor from the object structure can involve adjusting the next and previous links and child and parent links accordingly to remove the object representor concerned form the various lists. It is to be noted that the calling program does not have to perform the storage management operations (e.g., in the present instance adjusting the next and previous links and child and parent links) as the storage methodology is transparent to the calling program and they are carried out by the object space as a result of calling the remove operation.

The client can also initiate an add transaction to replace or add an object representor in the object structure. Adding an object representor to the object structure can involve adjusting the next and previous links and child and parent links accordingly to insert the object representor concerned at an appropriate position in the various lists.

A client can also initiate a notify transaction to alert the system that it is waiting for the object representor or to find out when the object representor is changed. In the case of the notify transaction, the object representor concerned is monitored for any change to it, and all those clients that issued notify requests to be informed of changes in/to that object are informed that the change has occurred and/or of the nature of the change.

It will be appreciated that the get, remove, add and notify operations can be compared to the read, take, write and notify operations, respectively, of JavaSpaces, except that in an embodiment of the invention they do not need to be, although they could be, implemented in the Java programming language.

In the object structure at least one of the object representor can define an object space. Indeed, a number of object representors can define different respective object spaces along side one another or nested within each other using next and previous or parent and child links, for example as illustrated in FIG. 8.

An example, in the C Language, of a structure used to represent an object will shortly be described with reference to Table 1. The structure keeps a template and instances separate to allow for objects that do not have instances (for example a class). The separation allows easy handling of object definition methods where object definitions are separate from instance, such as in XML, ASN1.

There can be several ways to refer to a template. To avoid overloading a specific definition, they can be kept separate. They can, however, be held in a generic object “struct)”

A template for an object can be accessed via a template handle (templatehdl) in the object itself. The template handle can be used by an object to hold an object handle (objHdl) for a template object describing the attributes or properties of the object. The template object's template field can be filled with attributes or whatever the calling program or application (the caller) wants to use to describe a related set of objects. For example the template object can be used to define the class like int x, float y for a set of instances, perhaps held as key value pairs, with x=1, y=10.0, x=3, y=20.0, meaning that each time an instance is added the types of properties are known. The template handle can allow access to a separate object meaning it can be held/access in the object space like any other object where its object handle is equal to the template handle used to access it—this template object itself has a template handle of 0 (to denote that it is a template) and its instance accesses (points to) a list of the attributes.

Thus, Table 1 below gives an example, in the C language, of an object representor (structure object, or “struct object”)

TABLE 1

typedef struct object {

char *objName;
char *objHdl;
char *objType;
lease_t lease;
char *templateHdl;
void *template;
void *instance;
struct object *next;
struct object *prev;
struct object *parent;
struct object *children;
struct object *c_next;
struct object *c_prev;
void *privateInfo;

} object_t;

In the object representor (structure object) illustrated in Table 1, the object name ObjName can be set by an entity-adding object. The object handle (objhdl) can be set by the object space software. The object type (objType) can, for example, be a MIME type. It is to be noted that the object type is of no interest to the object space itself—only the possible calling programs who will know what the type means and if they want it they can ask for it via the object space operations The lease time parameter (lease) can be the duration of the object in seconds.

In the above example, the template and the instance are void, as their type will depend on the objType of a particular object, and are both the list head for lists of representors (structure objects, or “struct objects”) specific to how the caller describes its objects and attributes in line with the decoupled approach where the object space is agnostic about the objects it holds once they conform to the representor or object struct above.

The link “struct object *next” provides a link, or pointer to the next object representor in a list of object representors. The link “struct object *prev” provides a link, or pointer to the previous object representor in a list of object representors.

Similarly the link “struct object *parent” provides a link, or pointer to the parent object representor in a hierarchy of object representors and the link “struct object *children” provides a link, or pointer to one or more child object representor in a hierarchy of object representors.

The line “void *privateInfo” can provide for additional object private data (type specific and opaque). For example, this could point to function pointers for parsing or for object statistics. It could be used, for example to hold relative time lease information (i.e. time of day to expire) where a lease time duration is sent as lease information in messages.

Tables 2 to 7 below illustrate examples of exported function prototypes

TABLE 2

```
int objectAdd(object_t **groupPPtr,
    object_t *parentPtr,
    object_t **objectPPtr,
    char *hash,
    char *objName,
    char *objType,
    void *privateInfo);
```

This adds an object of specified name and type into the object space, returning an object handle that can be used for subsequent access to the object.

TABLE 3

```
int objectRemove(object_t *groupPtr,
        char *hash,
        object_t *objectPtr,
        u_long instanceHandle)
```

This removes a specific Object from the object space.

TABLE 4

int objectNotify(object_t *, object_t * );

This is used by the calling program to register to be notified of a change in the object.

TABLE 5

```
int objectGet(object_t *groupPtr,
        char *hash,
        object_t *objectPtr,
        u_long instanceHandle)
```

This retrieves a copy of an object from the space that matches to the object passed in which may be a template to get a group of objects or be a specific instance, as determined by the caller.

TABLE 6

object_t *objectGetByHandle(char *, u_long);
object_t *objectGetByName(object_t *, char *);

These are utility functions that can access objects quickly (the first uses the handle returned on the objectAdd)

TABLE 7

objectLeaseRenew(object_t *object) or (lease_t lease)

This enables a lease time for an object in the object space to be renewed prior to expiry of the lease time.

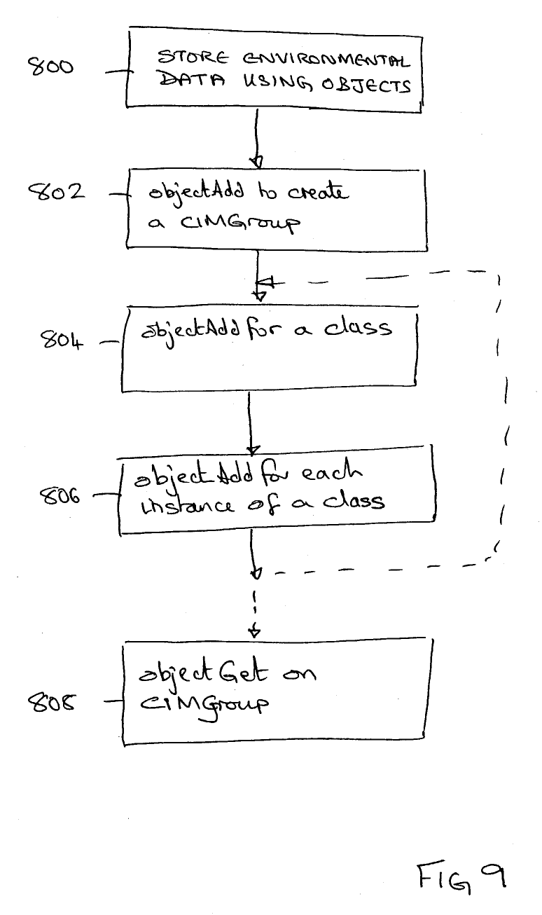

An example of the usage of an object space is illustrated with reference to FIG. 9.

In step 800 a calling program or application, for example a device management application, sets out to use objects to store environmental data about itself, perhaps using defined CIM Classes.

In step 802 the application can perform an objectAdd to create a CIMGroup into which it could put all CIM classes.

In step 804, the application can perform an objectAdd for a Sensor class into the CIMGroup in the space with its class definition object passed in as the template.

In step 806, the application can then treat this as a list for particular classes by doing objectAdd for each sensor with instances containing the values of each property/attribute of that sensor (as defined by its class in the template). In response to the objectAdd for each sensor, the appropriate instance and template pointers can be set up by the object space in the object (“representor”) struct.

Steps 804 and 806 can be repeated as required for different object classes. For example, in instead of, or in addition to the steps 804 and 806 for a sensor class, the application can perform and an objectAdd in step 804 for the Fan class into the CIMGroup in the object space with its class definition object passed in as the template. The application would then be able to do objectAdd for Fan instances in step 806.

To retrieve all the CIM Classes, in step 808 the application could perform an objectGet on the CIMGroup or, to get all Fan Instances, could perform an objectGet looking for the Fan Template or, to get a particular Fan instance, could perform an objectGet with the object passed in having the key CIM instance values filled in.

In the meantime, completely independent applications could also be using the object space for their objects arranged in a completely different way.

Accordingly, there has been described an object structure for defining objects in an object space that can separately identify instance information and descriptor information for an object to allow many different types of objects to be accommodated while still permitting access to the object structure through the use of simple functions such as add, remove, get, and notify functions.

The co-ordination of complex independent components (processes, threads, tasks, etc.) can be managed by linking those components together within a global environment that includes the object space.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. An object structure for defining objects in an object space, the object structure separately identifying at least instance information and descriptor information for an object.

2. The object structure of claim 1, further defining lease information for the object defining a minimum existence time for the object in the object space.

3. The object structure of claim 1, comprising an object representor representing a first object, the object representor referencing an instance representor that represents an instance of the first object and a descriptor representor representing a descriptor of the first object.

4. The object structure of claim 3, wherein the descriptor representor represents lease information defining a minimum existence time for the first object in the object space.

5. The object structure of claim 3, wherein the object representor references a first instance representor of a plurality of instance representors for respective instances of the first object.

6. The object structure of claim 3, wherein the object representor references a first descriptor representor of a plurality of descriptor representors for respective descriptors of the first object.

7. The object structure of claim 3, wherein the first object representor further includes one or more of:
name information for the first object;
handle information for the first object;
type information for the first object;
handle information for a descriptor for the first object; and
private information for the first object.

8. The object structure of claim 3, wherein the first object representor further includes link information to at least one of a next and a previous object representor in the object structure.

9. The object structure of claim 3, wherein the first object representor further includes link information to at least one of a parent and a child object representor for nested objects in the object structure.

10. The object structure of claim 1, wherein the object structure is accessible using functions selected from add, remove, get and notify functions.

11. The object structure of claim 1, wherein at least one object representor defines the object space.

12. An object space comprising an object structure that defines objects, the object structure separately identifying at least instance information and descriptor information for an object.

13. A method of providing an object framework for managing objects in an information system, the method comprising creating an object structure separately identifying at least instance information and descriptor information for an object.

14. The method of claim 13, further including lease information defining a minimum existence time for the object in an object space in the object structure.

15. The method of claim 13, comprising defining a first object representor for a first object, the object representor referencing an instance representor for an instance of the first object and referencing a descriptor representor for a descriptor of the first object.

16. The method of claim 15, further including lease information defining a minimum existence time for the first object in an object space in the descriptor representor.

17. The method of claim 15, further including in the first object representor, one or more of:
name information for the first object;
handle information for the first object;
type information for the first object;
handle information for a descriptor for the first object; and
private information for the first object.

18. The method of claim 15, further including, in the first object representor, link information to at least one of a next and a previous object representor in the object structure.

19. The method of claim 15, further including, in the first object representor, link information to at least one of a parent and a child object representor for nested objects in the object structure.

20. The method of claim 13, comprising accessing the object structure using functions selected from add, remove, get and notify functions.

21. The method of claim 13, comprising defining an object space using at least one structure object.

22. A carrier medium carrying program code operable to provide an object framework for managing objects in an information system, the program code creating an object structure separately identifying at least instance information and descriptor information for an object.

23. An object structure for defining objects in an object space, the object structure comprising first means for representing instance information for an object and second means for representing descriptor information for said object.
